(19) United States
(12) Patent Application Publication
(10) Pub. No.: US 2005/0083804 A1
(43) Pub. Date: Apr. 21, 2005

(54) Data recording and/or reproducing apparatus for recording data recording status information on optical disc, and optical disc therefor

(75) Inventors: Sung-hee Hwang, Seoul (KR); Jung-wan Ko, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/941,084

(22) Filed: Sep. 15, 2004

(30) Foreign Application Priority Data
Sep. 16, 2003 (KR) 2003-64159

(51) Int. Cl. G11B 5/09

(52) U.S. Cl. 369/47.22; 369/53.13

(57) ABSTRACT

A data recording and/or reproducing apparatus for recording data recording status information on an optical disc, and an optical disc therefor. In the optical disc in which a data area is divided into a plurality of sub data areas, a record map including a plurality of record map entries is recorded in a predetermined area arranged on the optical disc, and each of the record map entries includes location information of a sub data area among the plurality of sub data areas and recording status information of the sub data area. In the optical disc, more specific information on a data recording status is recorded such that a drive or a host receiving the more specific and accurate status information can effectively use the recording space of the disc.

### CROSS-REFERENCE TO RELATED APPLICATIONS

This application claims the priority of Korean Patent Application No. 2003-64159, filed on Sep. 16, 2003 in the Korean Intellectual Property Office, the disclosure of which is incorporated herein in its entirety by reference.

### BACKGROUND OF THE INVENTION

1. Field of the Invention

The present invention relates to a data recording and/or reproducing apparatus for recording data recording status information on an optical disc and an optical disc therefor.

2. Description of the Related Art

In the conventional technology, when user data is recorded on a write-once disc on which data can be recorded only once, a data area arranged in the write-once disc is divided into a plurality of sub data areas and user data is recorded in individual sub data areas. Also, in order to indicate the data recording status in the data area of the write-once disc, a record map is recorded in a predetermined area of the write-once disc.

The record map includes a plurality of record map entries. One record map entry includes the start address of one sub data area among the plurality of sub data areas included in the data area, and a last recorded address (LRA) on which user data is recorded last.

Each sub data area has two statuses. The first status is a closed status in which additional data recording in the sub data area is prohibited, and the second status is an open status in which additional data recording in the sub data area is permitted.

According to the conventional technologies as described above, a host or a drive cannot know whether or not data is recorded in an area after an LRA of a sub data area to the last address of the sub data area. Cases where data is recorded in the address after the LRA of a predetermined sub data area which is recorded in a predetermined record map entry, to the last address of the sub data area are as follows.

First, there is a case where while user data is recorded in a predetermined sub data area, an abnormal situation, such as power-down, takes place such that the user data recording is abnormally finished. At this time, a record map entry corresponding to the sub data area is not updated to reflect the data recorded immediately before the power-down, and in an area after the LRA recorded in the record map entry the data recorded immediately before the power-down is recorded.

Secondly, the LRA is a last address in which user data actually required by a host is recorded. Accordingly, there can be a padding area in which meaningless data is filled by a drive.

Accordingly, in the record map entry according to the conventional technologies, only the start address and LRA of a sub data area are recorded such that more specific information on the sub data area cannot be provided.

### SUMMARY OF THE INVENTION

In accordance with an aspect of the present invention, a data recording and/or reproducing apparatus which enables efficient use of a recording space, by providing more specific data recording status information on a data area, and an optical disc therefor are provided.

According to an aspect of the present invention, there is provided an optical disc in which a data area is divided into a plurality of sub data areas, wherein a record map including a plurality of record map entries is recorded in a predetermined area arranged on the optical disc, and each of the record map entries includes location information of a sub data area among the plurality of sub data areas and recording status information of the sub data area.

According to another aspect of the present invention, there is an apparatus recording and/or reproducing data including: a recording/reading unit which records data on or reads recorded data from an optical disc in which a data area is divided into a plurality of sub data areas; and a control unit which controls the recording/reading unit such that a record map including a plurality of record map entries is generated in a predetermined area arranged in the optical disc and is recorded, wherein each of the record map entries includes location information of a sub data area among the plurality of sub data areas and recording status information of the sub data area.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the present invention will become more apparent by describing in detail exemplary embodiments thereof with reference to the attached drawings of which:

FIGS. 1A and 1B are diagrams showing the structure of a write-once disc according to an embodiment of the present invention;

FIG. 2 is a diagram showing the structure of the recording layer of a single-recording-layer write-once disc or the first recording layer of a double-recording-layer write-once disc;

FIG. 3 is a diagram showing the structure of the second layer of a double-recording-layer write-once disc;

FIG. 4 is a diagram showing the data structure of a record map according to an embodiment of the present invention;

FIG. 5 is a diagram showing the structure of a record map entry according to the present invention;

FIG. 6 is a diagram showing an example of recording status information of a record map entry according to an embodiment of the present invention;

FIGS. 7A through 7C are diagrams explaining an example of a process of recovering a damaged area;

FIGS. 8A through 8C are diagrams explaining another example of a process of recovering a damaged area;

FIGS. 9A through 9C are diagrams explaining another example of a process of recovering a damaged area;

FIGS. 10A through 10C are diagrams explaining another example of a process of recovering a damaged area; and

FIG. 11 is a block diagram of an apparatus recording and/or reproducing data according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

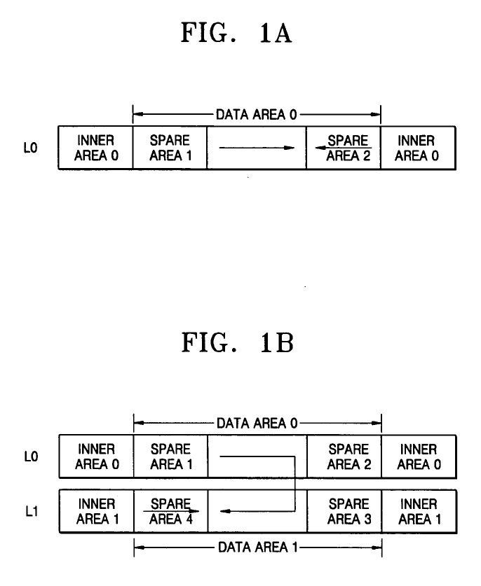

FIG. 1A shows a single-recording-layer write-once disc, and FIG. 1B shows a double-recording-layer write-once disc. In each data area, spare areas are arranged to be used for recording data to be recorded in a user data area when a defect occurs in the user data area. Arrows shown in the data areas in FIGS. 1A and 1B indicate the directions of using the user data areas.

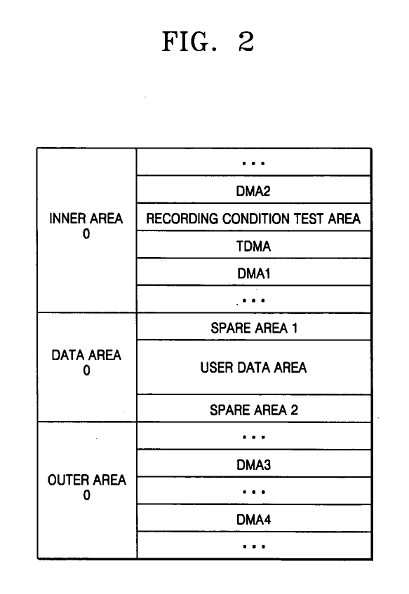

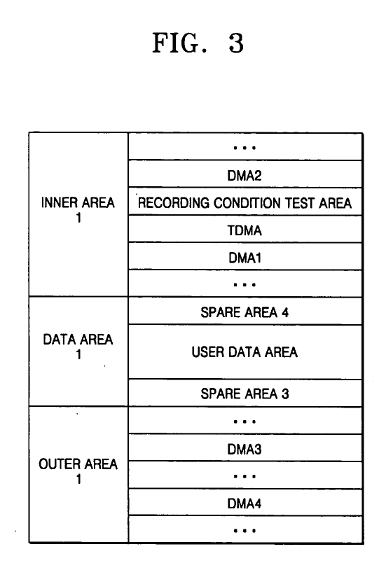

FIG. 2 is a diagram showing the structure of the recording layer of a single-recording-layer write-once disc or the first recording layer L0 of a double-recording-layer write-once disc, and FIG. 3 is a diagram showing the structure of the second layer L1) of a double-recording-layer write-once disc. The recording layer L0 of the single-recording-layer write once disc or each recording layer L0 and L1 of the double-recording-layer write once disc includes an inner area, a data area, and an outer area.

In each of the inner areas, a plurality of disc management areas (DMAs) that are defect management areas, a recording condition test area, and a temporary disc management area (TDMA) are arranged. In each data area, a plurality of spare areas and a user data area are arranged, and in each outer area, a plurality of DMAs that are additionally prepared defect management areas are arranged.

The TDMA in a write-once disc is allocated separately considering the characteristic of the medium. In the TDMA, temporary disc management structure information (TDMS) is recorded. The TDMS includes information for temporarily managing a defect that occurs when a write-once disc is used, and information for temporarily managing a disc, such as a record map indicating the recording status of a data area. Information on temporary defect management includes a temporary defect list (TDFL) and a temporary defect management structure (TDMS). The TDFL is information indicating the location where a defect occurs and the location of a spare area that replaces the defective area. The TDMS includes information on the location where the TDFL is recorded, and in addition, also includes information on the location and size of spare areas allocated when the disc is initialized, write prevention information, information on the location and size of the TDMA allocated to a data area, the LRA of the user data area, and so on. Also, the TDMS includes a record map according to an embodiment of the present invention.

The TDMA may be allocated to a data area when initialization of the write-once disc prior to using the medium is performed, according to selection of a drive manufacturer or a user. When the medium is initialized, according to the selection of the drive manufacturer or the user, whether or not the spare areas are allocated to the data area, and the size of the spare areas are determined.

When a write-once disc is finalized, final disc defect information and other information recorded in a TDMA are copied into a DMA while considering problems such as compatibility with other media.

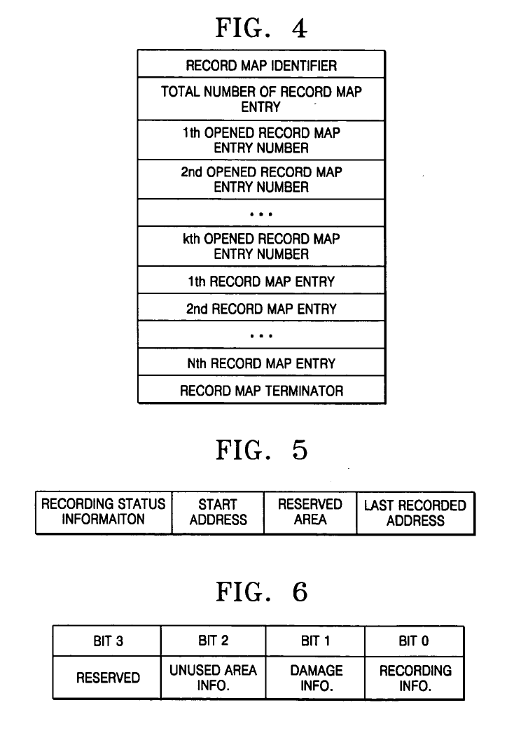

FIG. 4 is a diagram showing an embodiment of the data structure of a record map.

Referring to FIG. 4, the record map includes identification information of the record map identifier, the total number of record map entries included, k number of record entries each corresponding to sub data areas in open statuses in which additional data recording is permitted, N record map entries, and information indicating record map termination (record map terminator).

In the record map shown in FIG. 4, a total of N record map entries are recorded. N record map entries recorded in one record map indicates that a data area is divided into N sub data areas and used.

FIG. 5 is a diagram showing an embodiment of the structure of a record map entry. Referring to FIG. 5, the record map entry includes recording status information, the start address of a sub data area indicated by the record map entry, a reserved area, and a last recorded address (LRA) in which user data is recorded last. The recording status information is information indicating a data recording status (i.e., open or closed) of a sub data area indicated by the record map entry. The record map entry according to the embodiment shown in FIG. 5 is formed with, for example, 64 bits. Thus, for example, the recording status information is assigned 4 bits, the start address and the LRA are assigned 28 bits each, and the reserved area is assigned 4 bits.

FIG. 6 is a diagram showing an example embodiment of the recording status information of a record map entry. Referring to FIG. 6, the first bit, bit0, of the recording status information indicates whether the sub data area indicated by the corresponding record map entry is in a closed status or an open status. For example, if the value of bit0 is ‘1’, it indicates that the sub data area is in a closed status in which additional data recording is permitted and if the value of bit0 is ‘0’, it indicates that the sub data area is in an open status in which additional data recording is prohibited.

Bit1 indicates whether or not there is a damaged area in a sub data area indicated by the corresponding record map entry. For example, if the value of bit1 is ‘1’, it indicates that there is a damaged area in the sub data area, and if the value of bit1 is ‘0’, it indicates that there is no damaged area in the sub data area. The damaged area is, for example, an area in which while user data is recorded in a predetermined sub data area, an abnormal situation such as power-down occurs and the user data recording is abnormally finished such that data is partially recorded in the sub data area immediately before the power-down.

Bit2 indicates whether or not an unused area in which data can be recorded is in a sub data area indicated by the corresponding record map entry. For example, if the value of bit2 is ‘1’, it indicates that an unused area in which data can be recorded is not in the sub data area, and if the value of bit2 is ‘0, it indicates that an unused area is available in the sub data area.

Finally, bit3 is bit information reserved for data recording status information to be added later.

Meanwhile, when a damaged area occurs, for example, by power-down or power interruption of a drive while data is recorded in a write-once disc, identification and recovery jobs of the damaged area are required when the disc is placed again in the drive. Only after the identification and recovery of the damaged area are finished, record map entries including recording status information can be correctly updated.

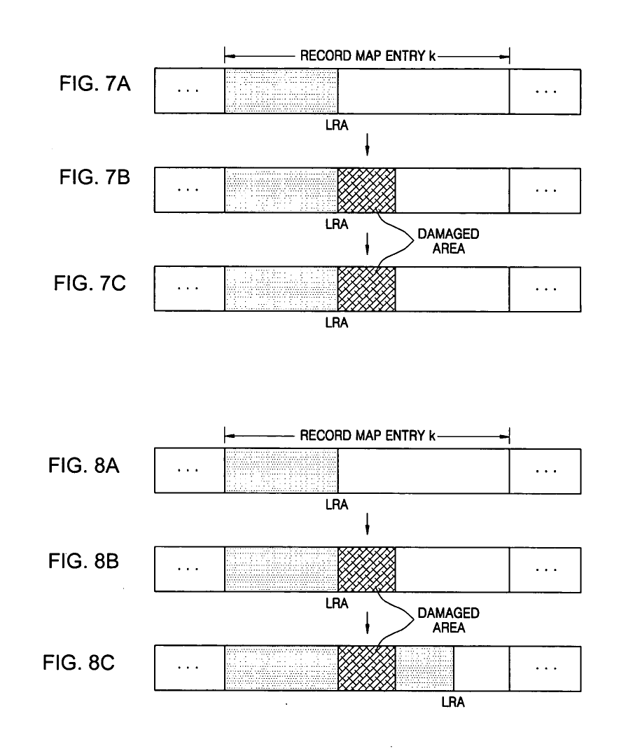

FIGS. 7A through 10C are diagrams showing a variety of examples showing the recovery process of a damaged area. FIGS. 7A, 8A, 9A, and 10A each show the recording status of sub data area k indicated by record map entry k. In sub data area k, user data is recorded from the start of the area to the LRA, and there is an ‘unused area’ after the LRA to the last of the sub data area where data recording is possible.

FIGS. 7B, 8B, 9B, and 10B each show the recording status of sub data area k, when data recording is finished abnormally without updating the record map in the TDMA due to reasons such as power-down of the drive. In the sub data area k, user data is normally recorded from the first of the area to the LRA, but the area after the LRA to a predetermined area is a damaged area caused by the abnormal power-down. Thus, the damaged area must be identified in order for the recording space of the disc to be used effectively.

A process of identifying a damaged area by a drive will now be explained in more detail. If a write-once disc is placed in the drive again, the drive reads a record map finally recorded in the TDMA and confirms the LRA of each sub data area in the data area. By searching the area after the LRA of each sub data area recorded in the record map, the drive checks whether or not data is recorded. If data is recorded after the LRA in a particular sub data area, the drive checks whether or not the data is valid user data recorded in a file system, by referring to the file system finally recorded in the write-once disc. If it is confirmed that the data is not recorded in the file system, the drive determines that the area after the LRA of the sub data area where data is recorded is a damaged area.

FIG. 7C shows a status in which sub data area k is closed by a drive or a host when a write-once disc is placed in the drive again after a damaged area occurs in sub data area k. The drive or the host updates the record map including new record map entry k in which the value of bit2 of the recording status information is ‘0’ and the values of bit1 and bit0 are ‘1’ as shown in FIG. 6.

FIG. 8C shows sub data area k in which when a write-once disc is placed in the drive again after a damaged area occurs in sub data area k, the drive confirms the damaged area and after the damaged area, data is additionally recorded. In this case, the LRA of the updated record map entry k is changed to the last address of the additionally recorded data and the value of the recording status information bit1 is ‘1’.

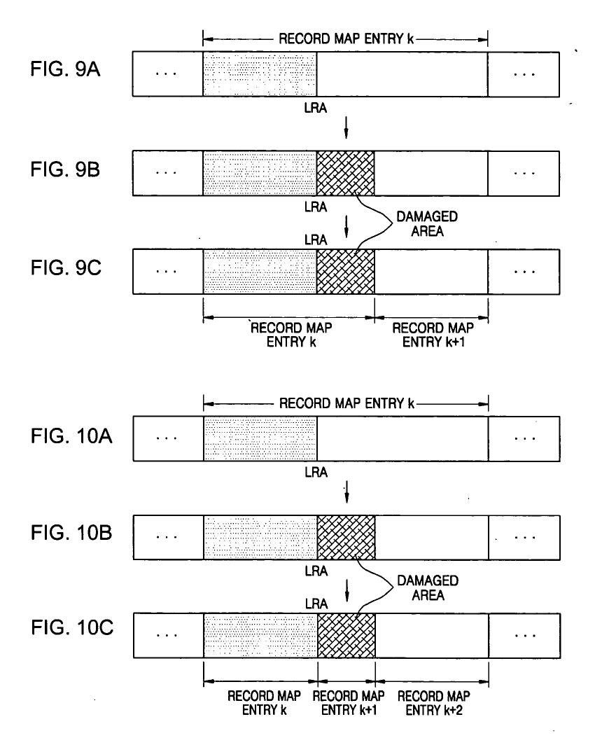

FIG. 9C shows a status in which when a write-once disc is placed in the drive again after a damaged area occurs in sub data area k, original sub data area k having the damaged area is then divided into two sub data areas, including new sub data area k and new sub data area k+1. At this time, the values of the recording status information bit0 through bit1 of the record map entry k are ‘1’ and a record map entry k+1 corresponding to the new sub data area k+1 is additionally recorded in the record map. Existing record map entries k+1, k+2, . . . , N are incremented by 1 to become k+2, k+3, . . . , N+1, respectively.

FIG. 10C shows a status in which when a write-once disc is placed in the drive again after a damaged area occurs in sub data area k, original sub data area k having the damaged area is then divided into three sub data areas, including new sub data area k, new sub data area k+1 and new sub data area k+2. The area in which user data is normally recorded before the damaged area is allocated as new sub data area k, the damaged area is allocated as new sub data area k+1, and the remaining area after the damaged area is allocated as new sub data area k+2.

At this time, the values of the recording status information bit0 and bit2 of record map entry k are ‘1’ and the value of bit1 is ‘0’. The values of the recording status information bit0 through b2 of record map entry k+1 corresponding to the new sub data area k+1 are ‘1’, since there is no user data in the new sub data area k+1 that is usable by the drive or host. Thus, the LRA of the new sub data area k+1 is recorded as 00h. The values of recording status information bit0 through b2 of record map entry k+2 corresponding to the new sub data area k+2 are ‘0’.

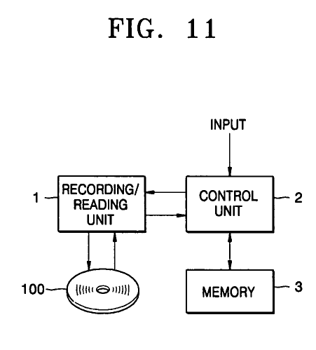

FIG. 11 is a block diagram of an apparatus recording and/or reproducing data according to an embodiment of the present invention.

The apparatus recording and/or reproducing data includes a recording/reading unit 1, a control unit 2, and a memory 3.

The recording/reading unit 1 records data on an optical disc 100 according to embodiments of the present invention and reads recorded data from the optical disc 100 under control of the control unit.

The optical disc 100 is a write-once disc and a data area in the disc is divided into a plurality of sub data areas.

The control unit 2 controls the recording/reading unit 1 such that the recording/reading unit 1 generates a record map including recording status information as described with respect to FIGS. 1-10C and then records the record map, for example, in the TDMA.

According to aspects of the present invention as described above, more specific information on a data recording status is recorded such that a drive or a host receiving the more specific and accurate status information can effectively use the recording space of the disc.

Although a few embodiments of the present invention have been shown and described, it would be appreciated by those skilled in the art that changes may be made in these embodiments without departing from the principles and spirit of the invention, the scope of which is defined in the claims and their equivalents.

1. An optical disc in which a data area is divided into a plurality of sub data areas, wherein a record map including a plurality of record map entries is recorded in a predetermined area arranged on a surface of the optical disc, and each of the record map entries includes location information of a corresponding sub data area among the plurality of sub data areas and recording status information of the corresponding sub data area.

2. The optical disc of claim 1, wherein the recording status information includes information indicating whether a damaged area incapable of recording data thereon is in the corresponding sub data area indicated by the record map entry.

3. The optical disc of claim 1, wherein the recording status information includes information indicating whether the corresponding sub data area indicated by the record map entry is a closed area in which additional data recording is prohibited, or an open area in which additional data recording is permitted.

4. The optical disc of claim 1, wherein the recording status information includes information indicating whether the corresponding sub data area indicated by the record map entry includes an area in which additional data recording is permitted.

5. The optical disc of claim 1, wherein the location information includes a start address of the corresponding sub data area indicated by the record map entry and a last address of user data which is recorded in the corresponding sub data area.

6. The optical disc of claim 5, wherein the recording status information includes information indicating whether a damaged area incapable of recording data therein is in the corresponding sub data area after the last address of the user data recorded in the corresponding sub data area.

7. The optical disc of claim 1, wherein the optical disc is a write-once optical disc, and the record map is updated when user data is recorded, the updated record map is accumulated.

8. The optical disc of claim 7, wherein the record map is recorded in a temporary disc management area of the write-once disc.

9. An apparatus recording and/or reproducing data, comprising:
a recording/reading unit which records the data on or reads the recorded data from an optical disc in which a data area is divided into a plurality of sub data areas; and
a control unit which controls the recording/reading unit such that a record map including a plurality of record map entries is recorded in a predetermined area arranged on the optical disc, wherein each of the record map entries includes location information of a corresponding sub data area among the plurality of sub data areas and recording status information of the corresponding sub data area.

10. The apparatus of claim 9, wherein the recording status information includes information indicating whether a damaged area incapable of recording data thereon is in the corresponding sub data area indicated by the record map entry.

11. The apparatus of claim 9, wherein the recording status information includes information indicating whether the corresponding sub data area indicated by the record map entry is a closed area in which additional data recording is prohibited, or an open area in which additional data recording is permitted.

12. The apparatus of claim 9, wherein the recording status information includes information indicating whether the corresponding sub data area indicated by the record map entry includes an area in which additional data recording is permitted.

13. The apparatus of claim 9, wherein the location information includes a start address of the corresponding sub data area indicated by the record map entry and a last address of user data which is recorded in the corresponding sub data area.

14. The apparatus of claim 13, wherein the recording status information includes information indicating whether a damaged area incapable of recording data therein is in the corresponding sub data area after the last address of the user data recorded in the corresponding sub data area.

15. A write-once optical disc for use with a recording/reproducing apparatus, comprising:
a first area having a first predetermined size storing defect management information;
a second area having a second predetermined size used to record user data from the recording/reproducing apparatus, the second area comprising a plurality of sub data areas; and
a third area having a third predetermined size storing data replacing defective units detected by the recording/reproducing apparatus within the second area based on the defect management information, wherein the defect management information includes a record map having a plurality of record map entries, and each of the record map entries includes location information indicating a start address and an ending address of a corresponding sub data area and recording status information of the corresponding sub data area.

16. The write-once disc of claim 15, wherein when the recording/reproducing apparatus records the user data in the corresponding sub data area the location information is updated to include a last recorded address of the corresponding sub data area.

17. The write-once disc of claim 16, wherein the recording/reproducing apparatus checks for a damaged data area recorded after the last recorded address but before the ending address of the corresponding sub data area, and the recording/reproducing apparatus reads the recording status information which indicates whether the corresponding sub data area is closed status which prohibits further recording or an open status which permits further recording.

18. The write-once disc of claim 17, wherein when the recording status information indicates that the corresponding sub data area is open status and the damaged data area is recorded, the recording/reproducing apparatus updates the record map entry of the corresponding sub data area to a new record map entry having the location information indicating the start address of the corresponding sub data area and a new ending address corresponding to a last address of the damaged data area, and adjusts remaining ones of the plurality of record map entries.

19. The write-once disc of claim 17, wherein when the recording status information indicates that the corresponding sub data area is open status and the damaged data area is recorded, the recording/reproducing apparatus updates the record map entry of the corresponding sub data area to a first new record map entry having first location information indicating the start address of the corresponding sub data area and a first ending address corresponding to a starting address of the damaged data area, a second new record map entry having second location information indicating a second start address corresponding to the starting address of the damaged data area and a second ending address corresponding to a last address of the damaged data area as a second sub data area, and a third new record map entry having third location information indicating a third start address corresponding to the last address of the damaged data area and the ending address of the corresponding sub data area as a third sub data area, and adjusts remaining ones of the plurality of record map entries.

20. The write-once disc of claim 17, wherein the recording/reproducing apparatus updates the recording status information to indicate that the damaged data area is present in the corresponding sub data area.
